(19) United States
(12) Patent Application Publication
(10) Pub. No.: US 2009/0075243 A1
(43) Pub. Date: Mar. 19, 2009

(54) Screw-thread fastener directional indicator

(76) Inventor: Lester Shepard, Chicago, IL (US)

Correspondence Address: McKenna McGovern Burkhart, 134 North LaSalle Street, Suite 2040, CHICAGO, IL, 60602, US

(21) Appl. No.: 11/901,143

(22) Filed: Sep. 14, 2007

(51) Int. Cl. G09B 19/00

(52) U.S. Cl. 434/258

(57) ABSTRACT

A threaded fastener drive simulator includes a threaded rod having first and second ends. A driver head is fixed to the first end of the threaded rod, and a threaded nut is threaded onto the rod in a position between the first and second ends of the threaded ro. A support assembly supports the threaded rod in such a way as to facilitate rotational movement of the driver head and the threaded nut in order to simulate movement of a threaded fastener to be driven. Using this mechanism prior to driving the fastener, the fastener drive simulator is actuated by orienting the fastener drive simulator in the same orientation as the fastener to be driven, and the drive head or nut is rotated to confirm the correct direction to rotate the fastener to affect desired movement of the fastener.

### CROSS-REFERENCE TO RELATED APPLICATIONS

None

### STATEMENT AS TO RIGHTS TO INVENTIONS MADE UNDER FEDERALLY-SPONSORED RESEARCH AND DEVELOPMENT

None

### FIELD OF THE INVENTION

The present invention relates generally to screw-thread fasteners, and specifically to proper actuation of screw-threaded fasteners.

### DESCRIPTION OF RELATED ART

Even though the concept of the screw dates back to around 200 B.C., the actual metal screw that is known today was not developed until the Renaissance. Early screws had to be handmade, so no two screws were ever alike. The time consuming process of hand filing the threads into the screw form made mass production and use virtually impossible. The first screw-cutting machine was invented in the sixteenth century in France, followed by incremental innovations leading to the paved the way for more innovations, culminating in the precursors to mass production machinery appearing in the mid-eighteenth century. The first power-driven, screw-cutting lathe was developed in the early nineteenth century, providing the basic manufacturing methods still in use today.

Today, machining of screws has been superseded by thread rolling. In 1836, American William Keane developed the thread rolling process, but at the time it had little success. The iron metal that was used to create the thread-rolled screws was too low grade and had the tendency to split during the die-cutting process. The eventual need to mass produce screws at a fraction of the cost of machining led to the reevaluation and establishment of the thread-rolling manufacture of screws, using easier-to-machine materials such as brass and steel.

Typically, screws, bolts, and bottle caps are loosened (moved towards the observer) counterclockwise and tightened (moved away from the observer) clockwise, in accordance with the “right-hand rule”. One mnemonic for remembering this is “righty-tighty, lefty-loosey” (right to tighten, left to loosen). The problem with the mnemonic is that it only works when viewing right and left relative to the top of the circle. When viewing relative to the bottom, the mnemonic becomes “lefty-tighty, righty-loosy”. In many applications, such as automobile maintenance and plumbing, the worker frequently finds himself in unusual orientations to reach difficult-to-access fasteners, making it even more confusing to determine the desired rotational direction. This difficulty is compounded when the fastener is in a “blind” location, out of sight of the worker.

A number of devices exist to test individual acuity in manipulating screw-threaded fasteners, and are represented in the patent literature. For example, U.S. Pat. No. 4,692,119 to Ussery is directed to an educational device that provides a three-dimensional, box-like structure and includes a plurality of side portions and a plurality of cross members selectively connectible to the side portions. A variety of threaded fasteners and tools are utilized for assembly of the educational device, which provides both an educational function in the use of different tools and threaded fasteners, as well as a toy providing a puzzle challenge by requiring a particular orientation of parts and threaded fasteners for complete assembly.

U.S. Pat. No. 6,142,786 to Culberson deals with an apparatus to educate a special needs child about shapes and hardware includes a working platform having three boards that each have one of three faces. A first face has colored areas with shaped openings in the colored areas, including round openings, square openings and triangular openings in respective ones of the colored areas. A second face has threaded openings, including openings equipped with bolts and openings to receive screws, and also including openings to receive pegs. A third face has an assortment of locks. The apparatus includes collections of pegs, threaded shafts, nuts, elastic bands and an internal box with internal compartments. The collections of items can be placed in the compartments or on the faces, as appropriate to assist a special needs child in learning skills needed in life.

U.S. Pat. No. 2,835,986 to Roeder shows a manipulative aptitude test apparatus including a board perforated with a plurality of transverse perforations. A bolt is seated within each perforation, and nuts are affixed to each of the bolts. A candidate assembles and disassembles the nut-and-bolt pairings to determine a time score.

U.S. Pat. No. 3,427,731 to DeBolt is concerned with an educational testing device similar to the Roeder apparatus.

U.S. Pat. No. 3,276,149 to Barnabas describes a dexterity testing device using wrenches and screwdrivers.

U.S. Pat. No. 2,669,061 to Orren shows a mechanic simulating toy with sound effects. Various nut and bolt simulations are employed.

U.S. Pat. No. 4,032,155 to Thomas refers to a toy or game is provided which comprises a block which may have cubical or other shape, and which is provided with a multiplicity of tapped holes therein of different diameters. A plurality of split bolts are also provided of different colors, sizes and head shapes, and the object of the game is to fit the proper halves together for each such bolt, to select the proper hole in the block into which the bolt may be fitted, and to screw each of the bolts into the proper hole

U.S. Pat. No. 4,457,722 to Houssand sets forth a educational toy having a substantially rectangular and planar base, a plurality of locks attached to a common side of the base and capable of adjustment to a locked or to an unlocked configuration, a plurality of fasteners adjustably mounted on the base, a tool for adjusting the fasteners, a knob threaded onto a bolt attached to the base, a pair of doors pivotally attached to the base and to at least one of the lock members such that the attached lock member can be adjusted to lock the doors in a closed configuration, and an image mounted on the base and positioned such that it is covered by the doors when in the closed configuration. The tool and all of the lock and fastener components are either attached to or tethered to the base so that the components cannot be lost

U.S. Pat. No. 6,746,373 to Bohmer details a exercise device is held in first one hand and then in the other hand, while the second hand is exercised by screwing nuts in on threaded rods against a spring resistance. Both right hand and left hand threads are provided so that exercise of clockwise and counterclockwise motions are required. The nuts have different outside diameters so that the gripping of the nuts will be at different positions to enhance the experience. Also provided are springs of different tensions to adjust the resistance to rotation.

Although these known devices provide some advantages, they present significant drawbacks as well. For example, the devices are intended largely for testing of coordination and the like, and have no utility for assisting mechanics in the field. It can be seen the foregoing that the need exists for a compact, simple, inexpensive, effective, and easy to use device for determining the proper rotational direction for screw-threaded fasteners.

### SUMMARY

In accordance with the principles of the present invention, a threaded fastener drive simulator includes a threaded rod having first and second ends. A driver head is fixed to the first end of the threaded rod, and a threaded nut is threaded onto the rod in a position between the first and second ends of the threaded rod. A support assembly supports the threaded rod in such a way as to facilitate rotational movement of the driver head and the threaded nut in order to simulate movement of a threaded fastener to be driven. Using this mechanism prior to driving the fastener, the fastener drive simulator is actuated by orienting the fastener drive simulator in the same orientation as the fastener to be driven, and the drive head or nut is rotated to confirm the correct direction to rotate the fastener to affect desired movement of the fastener.

The invention itself, however, both as to organization and method of operation, together with further objects and advantages thereof, may be best understood by reference to the following description taken in conjunction with the accompanying drawings.

### BRIEF DESCRIPTION OF THE DRAWINGS

FIG. 1 illustrates a threaded fastener drive simulator in accordance with the principles of the present invention.

FIG. 2 illustrates movement of a driver head portion of the threaded fastener drive simulator.

FIG. 3 illustrates movement of a threaded nut portion of the threaded fastener drive simulator.

FIG. 4 illustrates a threaded fastener drive simulator.

### DETAILED DESCRIPTION OF PREFERRED EMBODIMENTS

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

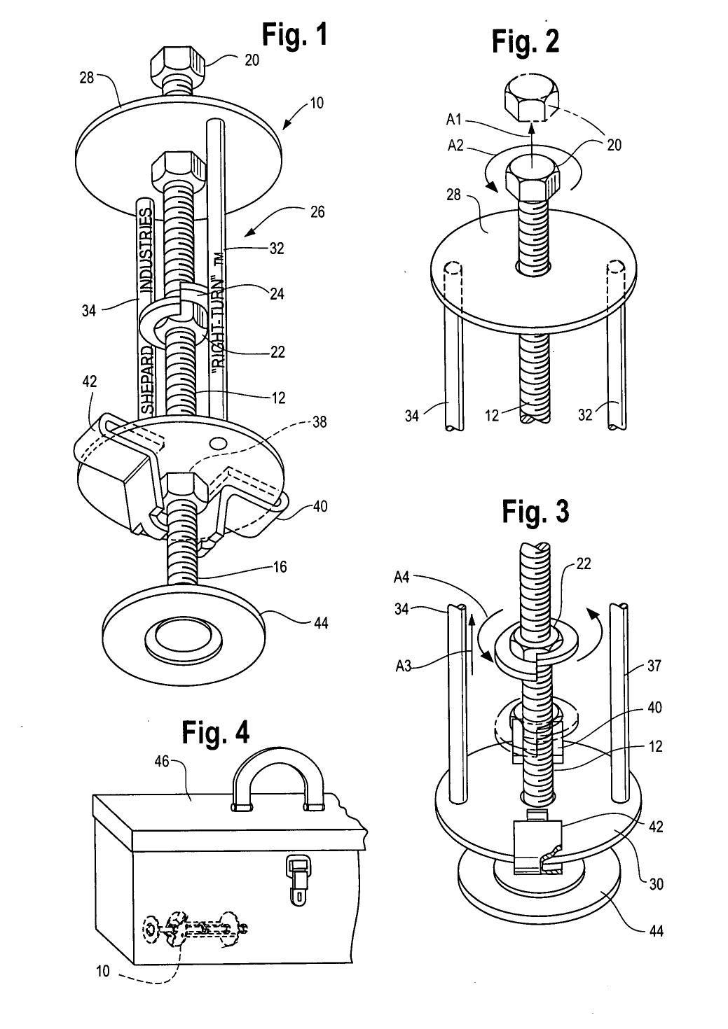

FIG. 1 illustrates a threaded fastener drive simulator 10 in accordance with the principles of the present invention. The threaded fastener drive simulator 10 includes a threaded rod 12 having first end 16 and a second end 18. A driver head, here shown as a hex head 20, is fixed to the first end 16 of the threaded rod 12. A threaded nut, here shown as a hex nut 22, is threaded onto the rod 12 in a position between the first and second ends 14, 16 of the threaded rod 12. The hex nut 22 can be provided with a grip extension 24 to enhance ease of manipulation of the hex nut 22. In the illustrated embodiment, the grip extension 24 is formed by securing a split washer onto the hex nut 22.

A support assembly 26 supports the threaded rod 12 in such a way as to facilitate rotational movement of the driver head 20 and the threaded nut 22 in order to simulate movement of a threaded fastener to be driven. The support assembly 26 includes a top 28 connected to a base member 30 via a pair of rigid frame elements 32, 34. Although the top 28 and base 30 can be provided in any suitable shape, it is contemplated that the generally circular configuration illustrated is particularly advantageous. The threaded rod 12 passes through threaded apertures 36, 38 in the top 28 and base 30, respectively. This relationship permits rotational movement of the threaded rod 12 to be translated into longitudinal movement with respect to the top 28.

A pair of handles 40, 42 are provided on the base member 30. The handles 40, 42 provide gripping surfaces above and below the base 30 to improve ease of handling of the fastener drive simulator 10. The dual handles 40,42 accommodate left-handed and right-handed users equally. A stand 44 is provided to allow the fastener drive simulator to stand upright on a flat surface.

Operation of the fastener drive simulator 10 is illustrated in FIGS. 2 and 3. First, the fastener drive simulator is oriented in the same orientation as the fastener to be driven. If the fastener to be driven is a bolt head (FIG. 2), the drive head 20 is rotated to confirm the correct direction to rotate the fastener to affect desired movement of the fastener. In FIG. 2, it is desired to loosen the fastener, i.e., to affect movement in the direction of the arrow A1. Manipulation of the head 20 will indicate to the user that the correct rotational direction to affect this movement is counterclockwise, as shown by arrow A2, since such rotation moves the head 20 upwardly with respect to the top 28. The user can then apply this movement to drive the fastener in the appropriate direction.

Similarly, if the fastener to be driven is a nut (FIG. 3), the threaded nut 22 is rotated to confirm the correct direction to rotate the fastener to affect desired movement of the fastener. In FIG. 3, it is desired to tighten the fastener, i.e., to affect movement in the direction of the arrow A3. Manipulation of the threaded nut 22 will indicate to the user that the correct rotational direction to affect this movement is clockwise, as shown by arrow A4, since such rotation moves the threaded nut downwardly with respect to the base 30. The user can then apply this movement to drive the fastener in the appropriate direction.

It is contemplated that indicia can be provided to enhance the utility of the fastener drive simulator 10. For example, providing the top 28 with a blue color, and the threaded nut 22 with a red color, helps to set the components apart from one another, making them easier to see and more attractive. Further, indicia such as advertising indicia can be applied, for example, to the support assembly 26.

As shown in FIG. 4, the fastener drive simulator 10 can be fabricated to have a size suitable sufficiently small to be stored in a standard tool box 46, along with other tools T. In one example, the threaded rod 12 can be provided as a length of approximately 6 inches, and the top 28 and base 30 with a diameter of approximately 2 inches, respectively.

It can be seen from the foregoing that the present invention provides advantages in a wide range of applications. While details of the invention are discussed herein with reference to some specific examples to which the principles of the present invention can be applied, the applicability of the invention to other devices and equivalent components thereof will become readily apparent to those of skill in the art. Accordingly, it is intended that all such alternatives, modifications, permutations, and variations to the exemplary embodiments can be made without departing from the scope and spirit of the present invention.

What is claimed is:

1. A threaded fastener drive simulator comprising the following:
a threaded rod having first and second ends;
a driver head fixed to the first end of the threaded rod;
a threaded nut threaded onto the rod in a position between the first and second ends of the threaded rod; and
a support assembly supporting the threaded rod, the support assembly being adapted and constructed to facilitate rotational movement of the driver head and the threaded nut to simulate movement of a threaded fastener to be driven;
whereby, prior to driving the fastener, the fastener drive simulator is actuated by orienting the fastener drive simulator in the same orientation as the fastener to be driven, and the drive head or nut is rotated to confirm the correct direction to rotate the fastener to affect desired movement of the fastener.

2. A threaded fastener drive simulator in accordance with claim 1, wherein the driver head comprises a hex head.

3. A threaded fastener drive simulator in accordance with claim 1, wherein the threaded nut comprises a hex nut.

4. A threaded fastener drive simulator in accordance with claim 1, wherein the support assembly comprises the following:
a top;
a base member; and
at least one frame element connecting the top to the base member.

5. A threaded fastener drive simulator in accordance with claim 4, wherein at least one of the top of the support assembly of the support assembly and the base of the support assembly comprises a threaded aperture receiving the threaded rod.

6. A threaded fastener drive simulator in accordance with claim 4, wherein the base of the support assembly comprises a stand.

7. A threaded fastener drive simulator in accordance with claim 4, wherein the top of the support assembly and the base of the support assembly are generally circular.

8. A threaded fastener drive simulator in accordance with claim 1, further comprising indicia on at least one part of the fastener drive simulator.

9. A threaded fastener drive simulator in accordance with claim 8, wherein the indicia appears on the support assembly.

10. A threaded fastener drive simulator in accordance with claim 8, wherein the indicia comprises at least one color.

11. A threaded fastener drive simulator in accordance with claim 8, wherein the indicia comprises color applied to at least one of the driver head and the threaded nut.

12. A threaded fastener drive simulator in accordance with claim 1, wherein the support assembly is constructed to be of a size sufficiently small to be stored in a standard tool box.

13. A threaded fastener drive simulator in accordance with claim 1, further comprising at least one handle secured to the support assembly.

14. A threaded fastener drive simulator in accordance with claim 1, wherein the at least one handle secured to the support assembly comprises a pair of handles secured to the base of the support assembly.

15. A threaded fastener drive simulator in accordance with claim 1, further comprising indicia on the driver head and the threaded nut.
